(19) United States
(12) Patent Application Publication
(10) Pub. No.: US 2024/0151381 A1
(43) Pub. Date: May 9, 2024

(54) HEADLAMP FOR A VEHICLE

(71) Applicant: Hella GmbH & Co. KGaA, Lippstadt (DE)

(72) Inventors: Christian Hüster, Salzkotten (DE); Boris Kubitza, Möhnesee-Körbecke (DE); Martin Plümpe, Paderborn (DE); Udo Venker, Güterlsoh (DE); Carsten Wilks, Lippstadt (DE)

(21) Appl. No.: 18/410,480

(22) Filed: Jan. 11, 2024

Related U.S. Application Data
(63) Continuation of application No. PCT/EP2022/069239, filed on Jul. 11, 2022.

(30) Foreign Application Priority Data
Jul. 12, 2021 (DE) 102021117875.4

(51) Int. Cl. F21S 41/64; F21S 41/153; F21S 41/16; F21W 102/135; F21Y 105/10; F21Y 115/10; F21Y 115/30

(52) U.S. Cl. CPC F21S 41/645; F21S 41/153; F21S 41/16; F21W 2102/135; F21Y 2105/10; F21Y 2115/10; F21Y 2115/30

(57) ABSTRACT

A headlamp for a vehicle is provided, and includes at least one light source and an optical element for generating a high beam light distribution and a low beam light distribution in front of the vehicle. The headlamp is designed to generate a high beam light distribution that contains at least one illuminated region, and at least one glare suppression region that is not lit. The headlamp is also designed to also generate a low beam light distribution that contains at least one illuminated region, and at least glare one suppression region that is not lit.

### CROSS REFERENCE

This application claims priority to PCT Application No. PCT/EP2022/069239, filed Jul. 11, 2022, which itself claims priority to German Application No. 10 2021 117875.4, filed Jul. 12, 2021, the entireties of both of which are hereby incorporated by reference.

### FIELD OF THE INVENTION

The present invention relates to a headlamp for a vehicle.

### BACKGROUND OF THE INVENTION

DE 10 2012 200 048 A1 discloses this type of headlamp. The headlamps described therein are designed to generate a high beam light distribution and a low beam light distribution in front of the vehicle. The headlamps can use a camera in the vehicle to identify traffic ahead of the vehicle or oncoming vehicles. In one of the embodiments described in DE 10 2012 200 048 A1, the headlamp can be pivoted horizontally and vertically, in order to move the high beam light distribution generated by the headlamp horizontally and vertically. As a result, a glare suppression region can be generated in a targeted manner that prevents blinding of an oncoming vehicle, for example.

The low beam light is an important component of vehicle lighting and legally required for all vehicles. It is used in particular to reliably illuminate the region directly in front of the vehicle without blinding other road users. There are special requirements regarding the luminosity and light distribution, in which the light distribution is normally asymmetrical. The low beam light also ensures that the vehicle itself can be easily seen by other road users in the dark.

FIG. 4 shows a typical asymmetrical low beam light distribution 1. The low beam light distribution 1 does not blind oncoming traffic in the other lane 2. The left-hand portion 3 of the low beam light distribution 1 directed toward the oncoming lane 2 on a straight road remains below the horizontal axis 4 at such an angle that the oncoming traffic is not blinded.

The right-hand portion 5 of the low beam light distribution1, which is directed higher, increases the range of visibility in the lane 6 that the vehicle is travelling in, and along the shoulder 7 of the road. The horizontal light/dark boundary 8 of the light distribution is higher in the right-hand portion 5 than in the left-hand portion 3 of the light distribution. There is a transition region 9 between the left and right portions 3, 5, where the vertical angle of the light distribution changes abruptly.

It is impossible to prevent oncoming traffic from looking directly into the headlamp in actual traffic conditions when traveling through a curve, turning, or due to dynamic vertical movements of the vehicle body. Even the low beam light can be blinding in these situations. By way of example, the higher right-hand portion of the low beam light distribution enters the other lane when traveling through a curve, thus blinding oncoming traffic. The same thing happens when turning, because the higher right-hand portion and the transition region enter the other lane briefly, potentially blinding others.

The light blinding others is even brighter when the vehicle is caused to move up and down on an uneven road surface. This not only has has a strong impact on the ability to distinguish contrast during the blinding moment, it also strongly reduces visual performance due to the need to adapt to the change in light directly after the blinding effect.

### BRIEF SUMMARY OF THE INVENTION

The fundamental object of the present invention is to create a headlamp of the type specified above, with which blinding other road users can be reduced or prevented when using the low beam lights.

The headlamp is designed to also generate a low beam light distribution that contains at least one illuminated region and at least one glare suppression region that is not lit. This results in a reduction or prevention of the blinding effect for oncoming traffic, or other vehicles traveling in the same direction, both during dynamic vertical movements of the vehicle body and when traveling through a curve or turning.

For this, the at least one glare suppression region in the high beam light distribution and/or low beam light distribution has a vertical light/dark boundary and a horizontal light/dark boundary. In particular, the at least one glare suppression region of the high beam light distribution and/or low beam light distribution is basically rectangular.

The headlamp can be configured to retain at least one property of the at least one glare suppression region, in particular its position and/or size and/or shape when switching from the high beam light distribution to the low beam light distribution, and/or from the low beam light distribution to the high beam light distribution. Consequently, light striking leading and oncoming traffic can be dimmed within whichever light distribution is being used.

The headlamp can contain numerous lighting elements for generating the pixels in a light distribution in a targeted manner. By actuating the lighting elements in a targeted manner, a glare suppression region can be generated in the low beam light distribution and/or high beam light distribution. The headlamp in this case can be a high resolution headlamp.

The lighting elements can be light emitting diodes or laser diodes, in particular in a solid-state LED array. In this case, the at least one light source is formed by the light emitting diodes or laser diodes. The lighting elements can also be part of a digital micromirror device or an LCoS or LCD. In this case, there is at least one additional light source that can light the active surface of the digital micromirror device or the LCoS or LCD.

The headlamp can contain a control unit that is configured to use information from at least one sensor in the vehicle to determine the position and/or size and/or shape of the at least one glare suppression region. This sensor can be a camera that is configured to record the region in front of the vehicle. The images recorded by the camera can be analyzed in order to identify objects such as other vehicles that are not to be blinded. A glare suppression region is then generated for the other vehicle.

The control unit can be configured to use information form the at least one sensor in the vehicle relating to dynamic vertical movements of the vehicle body and/or travelling through a curve and/or turning. Sensor data relating to horizontal angle changes when travelling through a curve or vertical angle changes when moving vertically can also be used, for example.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a typical low beam light distribution according to the prior art in front of a vehicle, indicated by lighter and darker regions, wherein the angles are measured in degrees along the horizontal and vertical axes;

FIG. 2 shows a first low beam light distribution generated in front of a vehicle by a headlamp according to the invention, indicated by lighter and darker regions, wherein the angles are measured in degrees along the horizontal and vertical axes;

FIG. 3 shows a second low beam light distribution generated in front of a vehicle by a headlamp according to the invention, indicated by lighter and darker regions, wherein the angles are measured in degrees along the horizontal and vertical axes; and

FIG. 4 shows a third low beam light distribution generated in front of a vehicle by a headlamp according to the invention, indicated by lighter and darker regions, wherein the angles are measured in degrees along the horizontal and vertical axes.

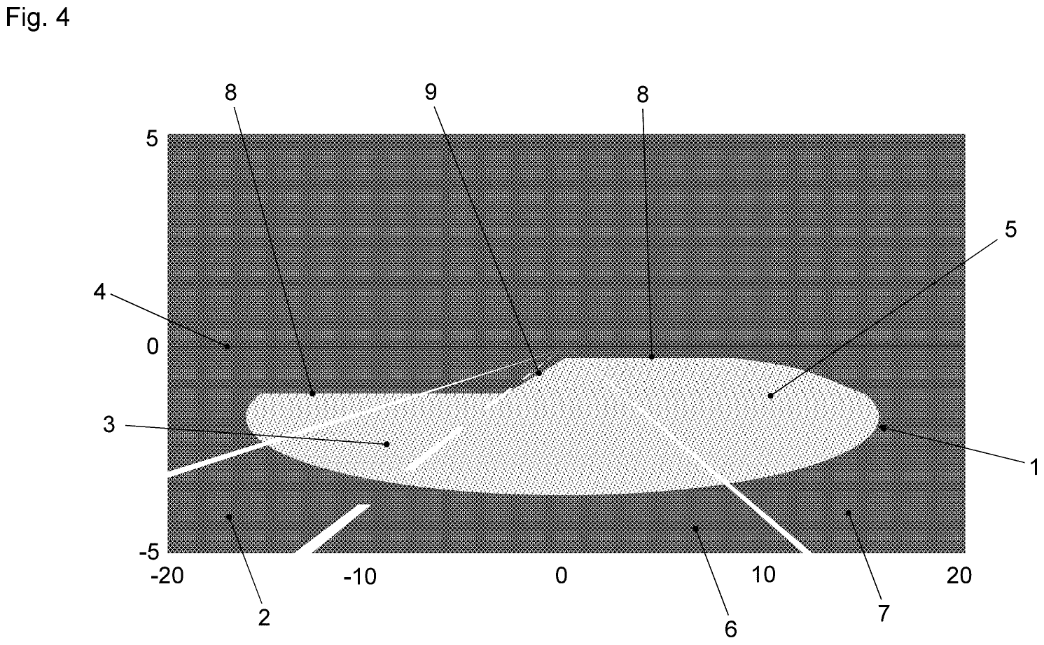

### DETAILED DESCRIPTION OF THE DRAWINGS

Identical and functionally identical parts and regions have the same reference symbols in the drawings.

The headlamp, not shown, has at least one light source and one optical element for generating a high beam light distribution and a low beam light distribution in front of the vehicle. The at least one light source can be a solid-state LED array containing numerous light emitting diodes (LEDs) arranged in a matrix, in which the individual light emitting diodes can be actuated individually and/or in groups in order to generate the pixels in a light distribution in a targeted manner. The optical element can be a projection lens, for example, that can project the light generated by the at least one light source toward the area in front of the vehicle.

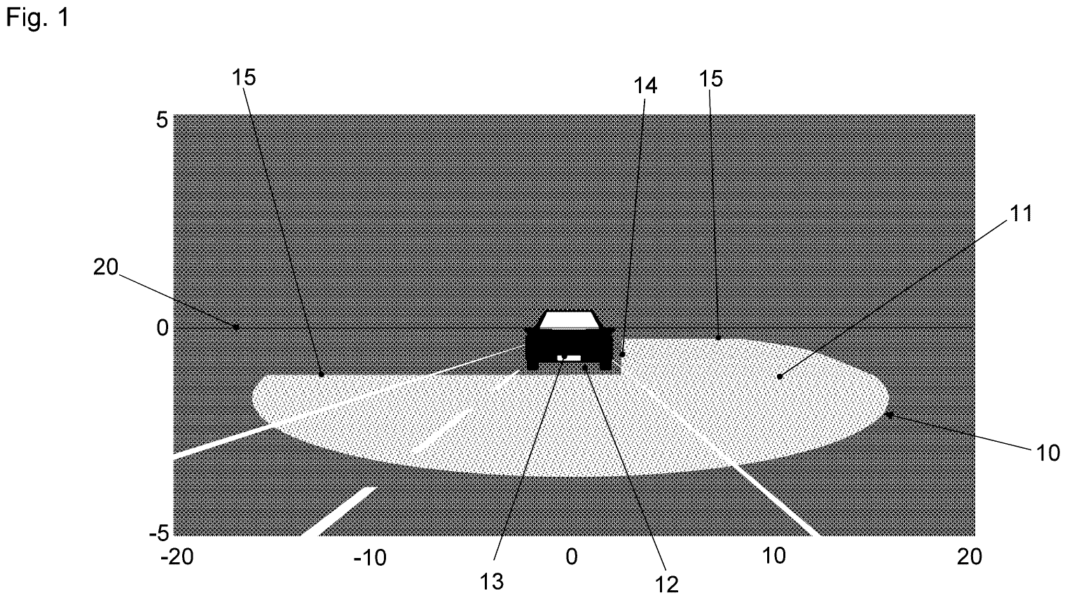

FIG. 1 shows a low beam light distribution 10 containing an illuminated region 11 and a glare suppression region 12 that is not lit. The glare suppression region 12 is within the low beam light distribution 10, in which the transition is normally located where the vertical angle of the light distribution changes abruptly. There is a vehicle 13 in this region in the situation illustrated in FIG. 1, which is why the control unit in the headlamp generates a glare suppression region 12 there. A vertical light/dark boundary is generated to the right of the vehicle 13 when this glare suppression region is formed, where the vertical angle of the upper boundary of the illuminated region changes abruptly, or the horizontal light/dark boundary 15 is lowered abruptly. There is no vertical light/dark boundary to the left of the vehicle 13.

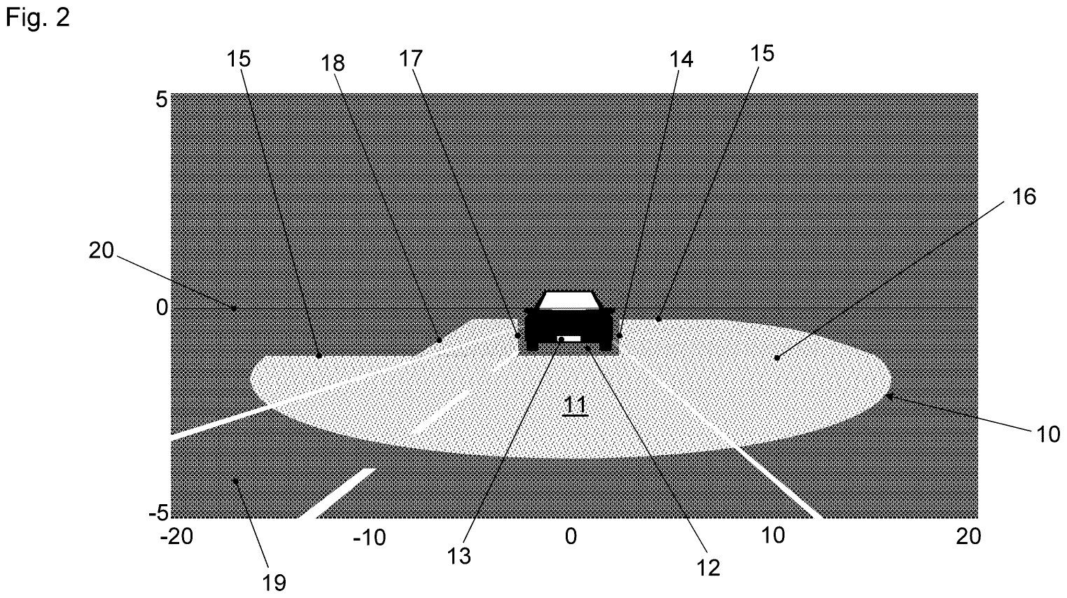

FIG. 2 also shows a low beam light distribution 10 that contains an illuminated region 11 and a glare suppression region 12 that is not lit. The low beam distribution in the situation illustrated in FIG. 2 is pivoted toward the left therein because the vehicle is travelling through a curve. The other vehicle 13 and the glare suppression region 12 surrounding it are located in the right-hand portion 16 of the low beam light distribution 10, which is typically higher. For this reason, the glare suppression region 12 in the situation shown in FIG. 2 is rectangular, with two vertical light/dark boundaries 14, 17.

Part of the right-hand portion 16 of the low beam light distribution 10 and the transition 18 are in the other lane 19. However, no oncoming traffic has been detected there, such that no further glare suppression region is generated in the low beam light distribution.

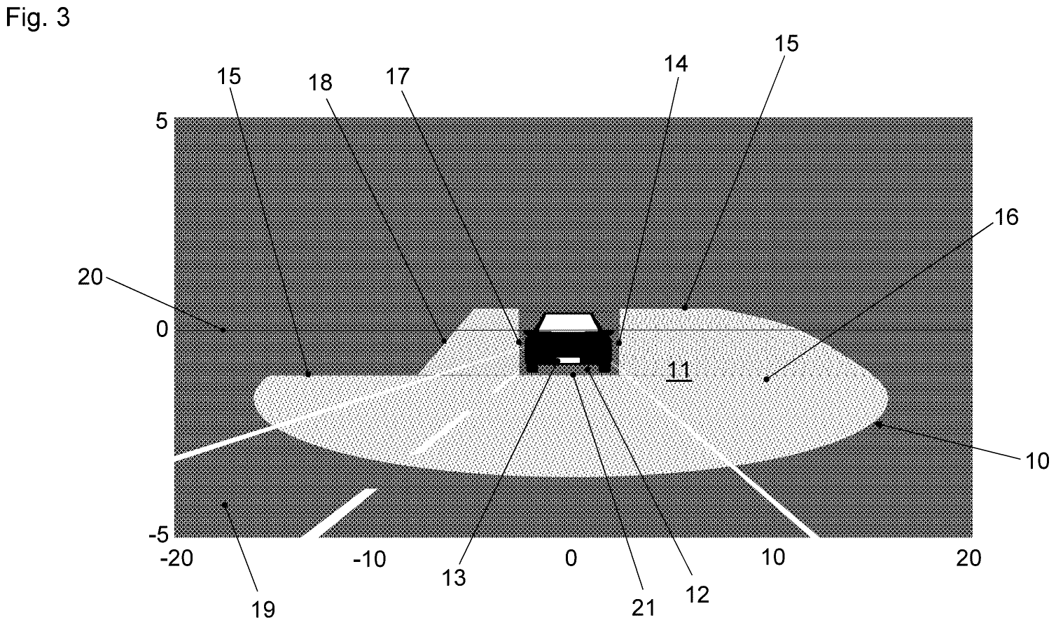

The low beam light distribution 10 shown in FIG. 3 substantially corresponds to that in FIG. 2. In this case, however, the low beam light distribution 10 is pivoted upward due to a vertical movement, such that the horizontal light/dark boundary 15, in particular in the low beam light distribution 10, is pivoted upward. Particularly in the right-hand portion 16 of the light distribution, the horizontal light/dark boundary 15 is above the horizontal axis 20.

The lower boundary 21 of the glare suppression region 12 is not pivoted upward therewith during the vertical movement. Instead, because the other vehicle 13 has been detected, the lower boundary 21 remains below it, such that the vertical extension of the glare suppression region 13 is greater than in the situation illustrated in FIG. 2.

There can be more than one glare suppression region in the low beam light distribution 10. By way of example, both the glare suppression region 12 in the situation shown in FIG. 1 can also be used as a glare suppression region for oncoming traffic, not shown therein.

### LIST OF REFERENCE SYMBOLS

1 low beam light distribution
2 other lane (oncoming traffic)
3 left-hand portion of the low beam light distribution
4 horizontal axis
5 right-hand portion of the low beam light distribution
6 lane in which the vehicle is travelling
7 shoulder of the road
8 horizontal light/dark boundary
9 transition between the left and right portions of the light distribution
10 low beam light distribution
11 illuminated region of the low beam light distribution
12 glare suppression region of the low beam light distribution
13 leading vehicle
14 vertical light/dark boundary
15 horizontal light/dark boundary
16 right-hand portion of the low beam light distribution
17 vertical light/dark boundary
18 transition between the left and right portions of the light distribution
19 other lane (oncoming traffic)
20 horizontal axis
21 lower boundary of the glare suppression region

1. A headlamp for a vehicle, the headlamp comprising:
at least one light source and
an optical element for generating a high beam light distribution and a low beam light distribution in front of the vehicle,
wherein the headlamp generates a high beam light distribution that contains at least one illuminated region and at least one glare suppression region that is not lit,
wherein the headlamp also generate a low beam light distribution that contains at least one illuminated region and at least glare one suppression region that is not lit.

2. The headlamp according to claim 1, wherein the at least one glare suppression region in the high beam light distribution and/or the low beam light distribution comprises a vertical light/dark boundary and a horizontal light/dark boundary.

3. The headlamp according to claim 1, wherein the at least one glare suppression region in the high beam light distribution and/or low beam light distribution is generally rectangular.

4. The headlamp according to claim 1, wherein the headlamp retains at least one property of the at least one glare suppression region, when switching from the high beam light distribution to the low beam light distribution or from the low beam light distribution to the high beam light distribution.

5. The headlamp according to claim 1, wherein the headlamp contains numerous lighting elements for generating pixels in a light distribution.

6. The headlamp according to claim 5, wherein the lighting elements are light emitting diodes or laser diodes.

7. The headlamp according to claim 5, wherein the lighting elements are part of a digital micromirror device or an LCoS display or LCD.

8. The headlamp according to claim 1, wherein the headlamp contains a control unit that uses information from at least one sensor in the vehicle to determine the position and/or size and/or shape of the at least one glare suppression region.

9. The headlamp according to claim 8, wherein the at least one sensor is a camera that records a region in front of the vehicle.

10. The headlamp according to claim 8, wherein the control unit uses information from the at least one sensor in the vehicle relating to dynamic vertical movement of the vehicle body and/or travel through curves and/or turning procedures.

11. The headlamp according to claim 4, wherein the property retained by the headlamp is its position and/or size and/or shape.

12. The headlamp according to claim 6, wherein the lighting elements are part of a solid-state LED array.
